(19) United States
(12) Patent Application Publication
(10) Pub. No.: US 2014/0329399 A1
(43) Pub. Date: Nov. 6, 2014

(54) CONNECTOR AND METHOD OF FILLING POTTING MATERIAL OF CONNECTOR

(71) Applicant: YAZAKI CORPORATION, Minato-ku, Tokyo (JP)

(72) Inventors: Hideki Ohsumi, Shizuoka (JP); Kazuhide Takahashi, Shizuoka (JP); Shigeru Tanaka, Shizuoka (JP); Haruki Tsuchiya, Shizuoka (JP)

(21) Appl. No.: 14/361,346

(22) PCT Filed: Nov. 5, 2012
(86) PCT No.: PCT/JP2012/007074

§ 371 Date: May 29, 2014

(30) Foreign Application Priority Data
Nov. 30, 2011 (JP) 2011-261928

(51) Int. Cl. H01R 13/52; H01R 43/24

(52) U.S. Cl. CPC H01R 13/5216; H01R 43/24
USPC 439/276; 264/272.11

(57) ABSTRACT

A connector (1) includes: a terminal receiving chamber (3) provided in a connector housing (2) and configured to receive therein (3) a terminal; and a potting material filling portion (9) provided in the terminal receiving chamber (3) with a potting material filled in the potting material filling portion (9), thus allowing the potting material filling portion (9) to seal the terminal receiving chamber (3). With respect to the potting material filling portion (9), based on an occurring stress characteristic showing a filling amount of the potting material relative to a stress occurring in the potting material filling portion (9) and based on a peel strength characteristic showing the filling amount of the potting material relative to a peel strength of the potting material filling portion (9), the filling amount of the potting material is set within such a range as that the peel strength becomes larger than the occurring stress.

### TECHNICAL FIELD

The present invention relates to a connector having such a structure as that the inside of a connector housing is sealed with a potting material and also to a method of filling the potting material of the connector.

### BACKGROUND ART

There is a connector mounted on a vehicular automatic transmission case (AT case) and used for an electric connection between an electric part in the automatic transmission case and an external electronic control unit (ECU). With respect to the above connector, it is necessary to secure sealability in the connector housing so as to prevent oil from leaking out from the inside of the automatic transmission case. Various connectors have been proposed which secure the sealability by filling a potting material in the connector housing (PTL 1: Japanese Patent Unexamined Publication No. 2001-126802, PTL 2: Japanese Patent Unexamined Publication No. 2006-228683 and PTL 3: Japanese Patent Unexamined Publication No. 2002-270283).

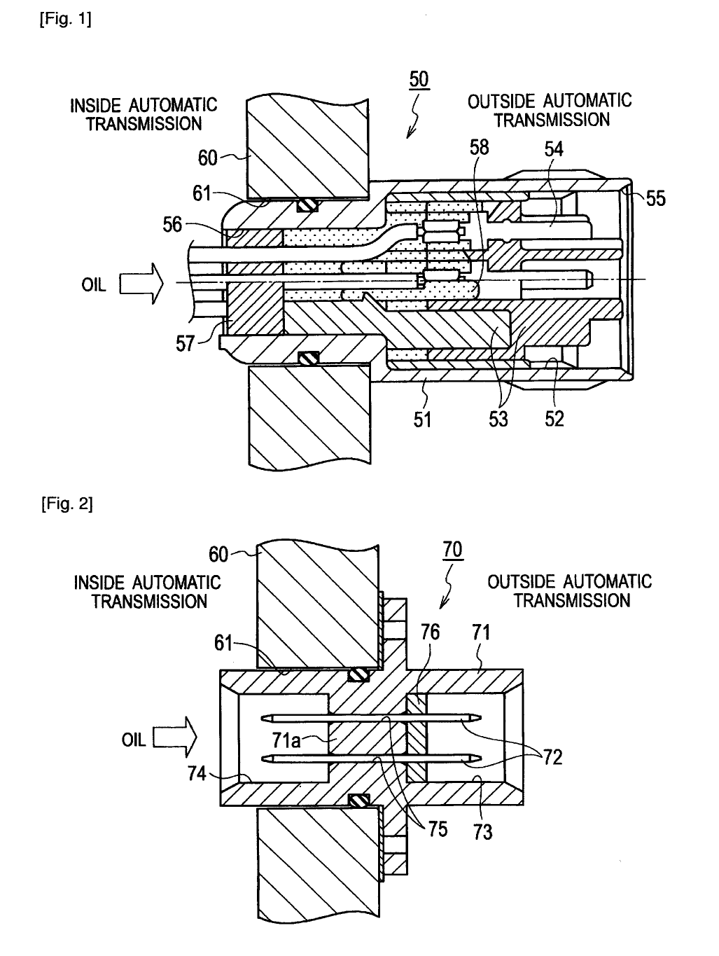

FIG. 1 shows a first conventional example of a connector of this type. In FIG. 1, a connector 50 is mounted on a connector mounting hole 61 of an automatic transmission case 60. The connector 50 is provided with a connector housing 51 including a terminal receiving chamber 52, an inner plate 53 disposed in the terminal receiving chamber 52 and a terminal 54 held by the inner plate 53. The terminal receiving chamber 52 has a first side opened to a connector mating opening 55 and a second side opened to an electric wire pulling outlet 56. A rubber plug 57 is mounted on the electric wire pulling outlet 56 side of the terminal receiving chamber 52. A potting material filling portion 58 filled with a potting material is provided at a portion receiving the inner plate 53, the terminal 54 and the like inside the terminal receiving chamber 52.

Oil having entered through a gap of the electric wire pulling outlet 56 into the terminal receiving chamber 52 is prevented by the potting material filling portion 58 from leaking out of the automatic transmission case 60 through the terminal receiving chamber 52.

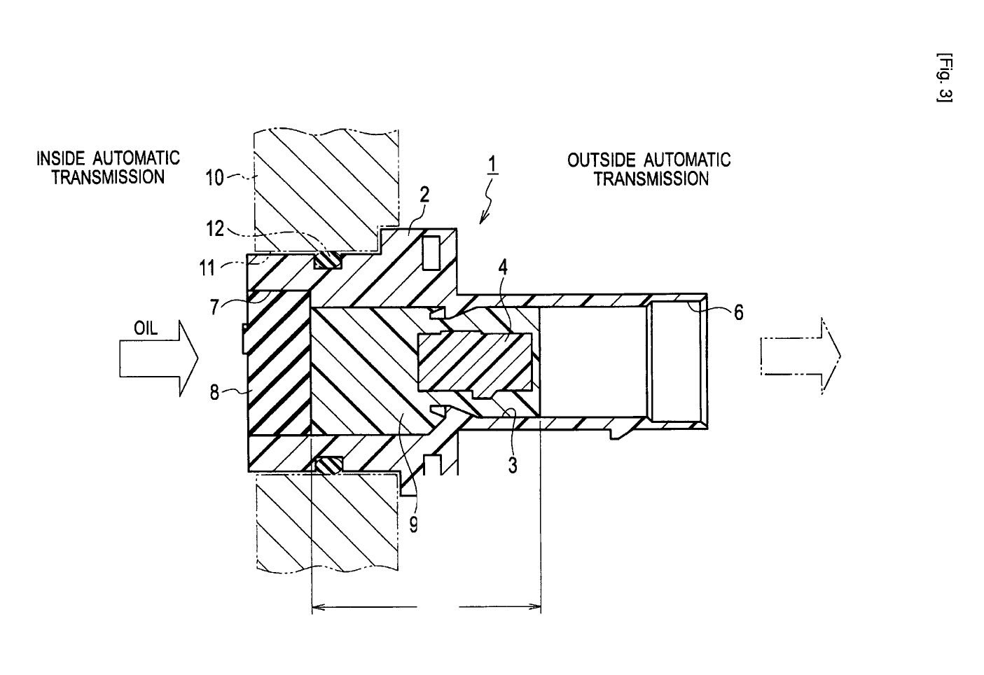

FIG. 2 shows a second conventional example a connector of this type. In FIG. 2, a connector 70 is mounted on the connector mounting hole 61 of the automatic transmission case 60. The connector 70 is provided with a connector housing 71 and a terminal 72 received in the connector housing 71. The connector housing 71 is provided with a pair of first and second terminal receiving chambers 73, 74 with a middle partition wall 71 a as a boundary. A terminal mounting hole 75 is provided in the middle partition wall 71a. The terminal 72 goes through the terminal mounting hole 75. The going-through terminal 72 has end sides thereof respectively protruding toward a pair of the first and second terminal receiving chambers 73, 74. A potting material filling portion 76 filled with a potting material is provided in the first terminal receiving chamber 73 disposed outside the automatic transmission case 60.

The oil having entered into the second terminal receiving chamber 74 tries to enter into the first terminal receiving chamber 73 through the terminal mounting hole 75. However, the potting material filling portion 76 dams the oil, thus preventing the oil from leaking out through the first terminal receiving chamber 73.

### CITATION LIST

### Patent Literature

[PTL 1]

Japanese Patent Unexamined Publication No. 2001-126802

[PTL 2]

Japanese Patent Unexamined Publication No. 2006-228683

[PTL 3]

Japanese Patent Unexamined Publication No. 2002-270283

### SUMMARY OF INVENTION

### Technical Problem

However, according to the first and second conventional examples, it was common to fill the potting material in the connector housings 51, 71 and then evaluate the sealability of the product, to thereby verify the performance. Thus, the sealability of the connectors 50, 70 significantly depends on the performance of the potting material, without taking into account the filling amount of the potting material. Thus, an excessive filling of the potting material caused a larger-size and a higher cost.

Recently, a demand for securing the sealability of the connectors 50, 70 as well as demands for smaller size and lower cost are uprising, necessitating to provide a connector capable of meeting such demands.

To solve the above problems, it is, therefore, an object of the present invention to provide a connector and a method of filling potting material of the connector which can accomplish securing of salability as well as smaller size and lower cost.

### Solution to Problem

According to a first aspect of the present invention, there is provided a connector including: a terminal receiving chamber provided in a connector housing and configured to receive therein a terminal; and a potting material filling portion provided in the terminal receiving chamber and configured to seal the terminal receiving chamber with a potting material filled in the potting material filling portion With respect to the potting material filling portion, based on an occurring stress characteristic showing a filling amount of the potting material relative to a stress occurring, under a predetermined environmental condition, in the potting material filling portion and based on a peel strength characteristic showing the filling amount of the potting material relative to a peel strength at a boundary interface of the potting material filling portion, the filling amount of the potting material is set within such a range as that the peel strength becomes larger than the occurring stress.

According to a second aspect of the present invention, there is provided a method of filling a potting material of a connector, including: providing, in a connector housing, a terminal receiving chamber for receiving therein a terminal; obtaining: an occurring stress characteristic showing a filling amount of the potting material to be filled in the terminal receiving chamber relative to a stress occurring, under a predetermined environmental condition, in the potting material, and a peel strength characteristic showing the filling amount of the potting material relative to a peel strength at a boundary interface of the potting material; setting, based on the occurring stress characteristic and the peel strength characteristic, the filling amount of the potting material within such a range as that the peel strength becomes larger than the occurring stress; and filling the potting material in the terminal receiving chamber based on the set filling amount and thereby to seal the terminal receiving chamber.

### ADVANTAGEOUS EFFECTS OF INVENTION

According to the first and second aspects of the present invention, with respect to the potting material filing portion, the filling amount of the potting material is determined based on the occurring stress characteristic and the peel strength characteristic within such a range as that the peel strength becomes larger than the occurring stress, thus enabling to accomplish a requisite minimum of the filling amount while securing the sealability. Thus, the sealability of the connector can be secured and the smaller size and lower cost can be accomplished.

### BRIEF DESCRIPTION OF DRAWINGS

### [FIG. 1]

FIG. 1 is a cross sectional view of a connector according to a first conventional example of the present invention.

### [FIG. 2]

FIG. 2 is a cross sectional view of a connector according to a second conventional example of the present invention.

### [FIG. 3]

FIG. 3 shows an embodiment of the present invention, which is a cross sectional view of a connector.

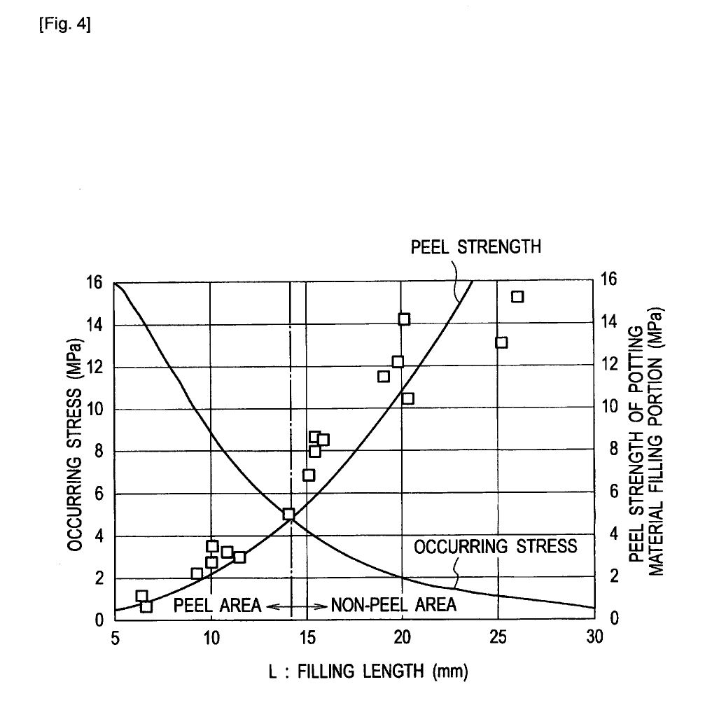

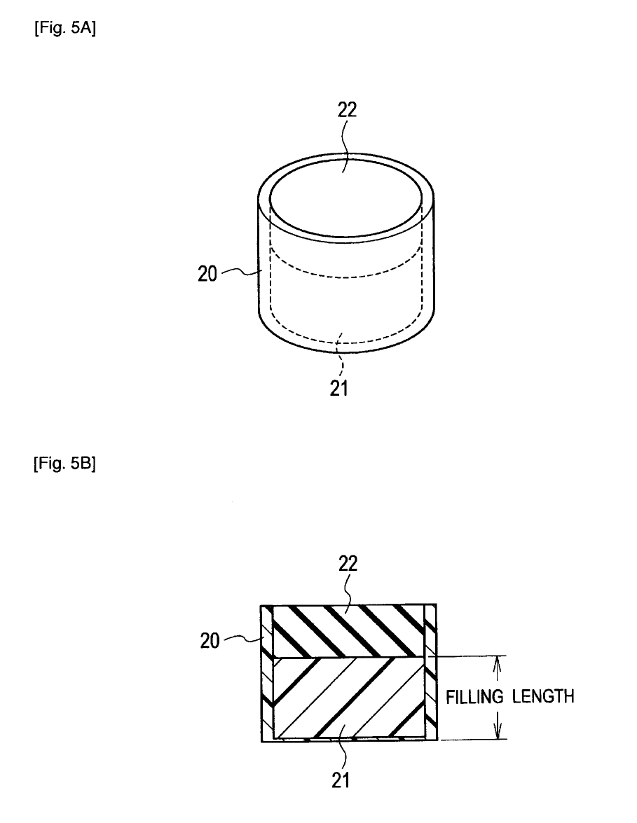

### [FIG. 4]

FIG. 4 shows the embodiment of the present invention, which is an occurring stress characteristic showing a filling length (filling amount) of a potting material relative to an occurring stress occurring, under a predetermined environmental condition, in the potting material filling portion and a peel strength characteristic showing the filling length (filling amount) of the potting material relative to the peel strength of the potting material filling portion.

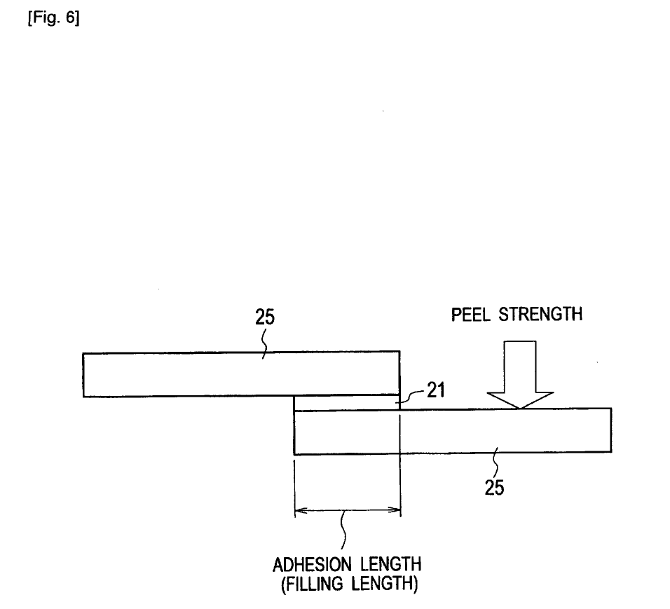

### [FIG. 5A]

FIG. 5A shows the embodiment of the present invention, which is a perspective view for explaining a method of calculating the filling length (filling amount) of the potting material relative to the occurring stress occurring, under the predetermined environmental condition, in the potting material filling portion.

### [FIG. 5B]

FIG. 5B is a cross sectional view of FIG. 5A.

### [FIG. 6]

FIG. 6 shows the embodiment of the present invention, which is a peel strength characteristic showing the filling length (filling amount) of the potting material relative to the peel strength of the potting material filling portion.

### DESCRIPTION OF EMBODIMENTS

Hereinafter, one embodiment of the present invention will be explained with the accompanying drawings.

FIG. 3 is a connector 1 according to the embodiment of the present invention. In FIG. 3, the connector 1 is mounted on a connector mounting hole 11 of an automatic transmission case 10. An O-ring 12 is intervened between an outer periphery of the connector 1 and a peripheral face of the connector mounting hole 11.

The connector 1 is provided with a connector housing 2 including a terminal receiving chamber 3 inside the connector housing 2, an inner plate 4 disposed in the terminal receiving chamber 3 and a terminal (not shown) held by the inner plate 4. The terminal receiving chamber 3 has a first side communicating with a connector mating opening 6 and a second side communicating with an electric wire pulling outlet 7. The connector mating opening 6 is opened to outside of the automatic transmission case 10 while the electric wire pulling outlet 7 is opened inside the automatic transmission case 10.

A rubber plug 8 is mounted on the electric wire pulling outlet 7 side of the terminal receiving chamber 3. The rubber plug 8 is provided with an electric wire inserting hole (not shown). An electric wire (not shown) connected to the terminal (not shown) through the electric wire inserting hole is pulled out into the automatic transmission case 10. A potting material filling portion 9 filled with a potting material (for example, epoxy resin) is provided at a portion receiving the terminal and inner plate 4 inside the terminal receiving chamber 3.

As shown in FIG. 4, with respect to the potting material filling portion 9, based on an occurring stress characteristic showing a filling length (filling amount) L of the potting material relative to a stress occurring, under a predetermined environmental condition, in the potting material filling portion 9 and based on the peel strength characteristic showing the filling length (filling amount) L of the potting material relative to the peel strength at the boundary interface of the potting material filling portion 9, the filling length (filling amount) L of the potting material in the potting material filling portion is set within such a range as that the peel strength becomes larger than the occurring stress. Specifically, with an intersection (filling length: about 14 mm) of the occurring stress characteristic curve and the peel strength characteristic curve used as a reference, the filling length (filling amount) L is so set as to have the peel strength slightly larger than the occurring stress.

In FIG. 4, with the intersection (filling strength: about 14 mm) of the occurring stress characteristic curve and the peel strength characteristic curve used as a reference, the area with the filling length L smaller than 14 mm is defined as a peel area while the area with the filling length L larger than 14 mm is defined as a non-peel area.

The occurring stress characteristic described above was obtained by a stress simulation (analysis by finite element method). That is, as shown in FIG. 5A and FIG. 5B, an epoxy resin (potting material) 21 is filled in a cylindrical case (equivalent to the connector housing 2) having a bottom and is blocked with a bush (equivalent to the rubber plug 8) 22. The filling length of the epoxy resin (potting material) 21 was varied (5 mm to 30 mm) and the stress change (change of deformation center position) caused when the epoxy resin (potting material) 21 was subjected to a thermal contraction at a low temperature (a predetermined environmental condition) was calculated through a predetermined calculation.

The peel strength characteristic described above was obtained by an actual measurement using a test piece 25. That is, as shown in FIG. 6, two test pieces 25 each in a form of a strip were adhered with the potting material (epoxy resin) 21 and then the adhesion length (equivalent to the filling length) was varied (5 mm to 30 mm) to thereby obtain the peel load.

With the connector 1 described above, based on the occurring stress characteristic showing the filling amount of the potting material relative to the stress occurring, under the predetermined environmental condition, in the potting material and based on the peel strength characteristic showing the filling amount of the potting material relative to the peel strength at the boundary interface of the potting material, the filling length L of the potting material filling portion 9 is set within such a range as that the peel strength becomes larger than the occurring stress. Thus, the potting material filling portion 9 is not peeled on the boundary interface with the connector housing 2 by the occurring stress attributable to, for example, the thermal contraction at a low temperature, thus enabling to secure the sealability by dint of the potting material filling portion 9. Then, the filling amount (filling length) of the potting material is determined based on the occurring stress characteristic and the peel strength characteristic, thus enabling to set a requisite minimum of the filling amount for securing the sealability. Thus, the sealability of the connector 1 can be secured, and the smaller size and lower cost can be accomplished.

The occurring stress characteristic and peel strength characteristic of the potting material filling portion 9 each differ with the type of selected potting material, thus enabling to set the requisite minimum of the filling amount according to the selected potting material.

According to the embodiment, the occurring stress characteristic is calculated through the stress simulation (analysis by finite element method). However, the occurring stress characteristic may be, as a matter of course, calculated by any other method.

According to the embodiment, the peel strength characteristic is calculated by the actual measurement using the test piece. However, the peel strength characteristic may be, as a matter of course, obtained by any other method.

According to the embodiment, the potting material is the epoxy resin. However, the potting material may be, as a matter of course, a seal material other than the epoxy resin.

The connector 1 according to the embodiment is mounted on the vehicular automatic transmission case (AT case) and is used for the electric connection between the electric part in the automatic transmission case and the external electronic control unit (ECU). However, the connector 1 may be, as a matter of course, applied to various portions in need of water-proof and the like.

1. A connector comprising:
a terminal receiving chamber provided in a connector housing and configured to receive therein a terminal; and
a potting material filling portion provided in the terminal receiving chamber and configured to seal the terminal receiving chamber with a potting material filled in the potting material filling portion,
wherein with respect to the potting material filling portion, based on an occurring stress characteristic showing a filling amount of the potting material relative to a stress occurring, under a predetermined environmental condition, in the potting material filling portion and based on a peel strength characteristic showing the filling amount of the potting material relative to a peel strength at a boundary interface of the potting material filling portion, the filling amount of the potting material in the potting material filling portion is set within such a range as that the peel strength becomes larger than the occurring stress.

2. The connector according to claim 1, wherein the filling amount of the potting material in the potting material filling portion is set such that the peel strength becomes slightly larger than the occurring stress.

3. A method of filling a potting material of a connector, comprising:
providing, in a connector housing, a terminal receiving chamber for receiving therein a terminal;
obtaining:
an occurring stress characteristic showing a filling amount of the potting material to be filled in the terminal receiving chamber relative to a stress occurring, under a predetermined environmental condition, in the potting material, and
a peel strength characteristic showing the filling amount of the potting material relative to a peel strength at a boundary interface of the potting material;
setting, based on the occurring stress characteristic and the peel strength characteristic, the filling amount of the potting material within such a range as that the peel strength becomes larger than the occurring stress; and
filling the potting material in the terminal receiving chamber based on the set filling amount, thereby to seal the terminal receiving chamber.

4. The method of filling the potting material of the connector according to claim 3, wherein
the setting of the filling amount of the potting material is such that the peel strength becomes slightly larger than the occurring stress.
